(19) United States
(12) Patent Application Publication
(10) Pub. No.: US 2010/0204841 A1
(43) Pub. Date: Aug. 12, 2010

(54) METHODS AND APPARATUS FOR PROVIDING LED-BASED SPOTLIGHT ILLUMINATION IN STAGE LIGHTING APPLICATIONS

(75) Inventors: Brian CHEMEL, Marblehead, MA (US); Michael K. BLACKWELL, Milton, MA (US); Colin PIEPGRAS, Swampscott, MA (US); John WARWICK, Somerville, MA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/676,469

(22) PCT Filed: Sep. 5, 2008
(86) PCT No.: PCT/US08/75441

§ 371 Date: Mar. 4, 2010

Related U.S. Application Data
(60) Provisional application No. 60/970,781, filed on Sep. 7, 2007.

(51) Int. Cl. G05D 23/19; H01J 13/32; G05D 7/06

(52) U.S. Cl. 700/282; 315/113

(57) ABSTRACT

Methods and apparatus for providing theatrical illumination. In one example, a modular lighting fixture (300) has an essentially cylindrically-shaped housing (320) including first openings (325) for providing an air path through the lighting fixture. An LED-based lighting assembly (350) is disposed in the housing and comprises an LED module (360) including a plurality of LED light sources (104), a first control circuit (368, 370, 372) for controlling the light sources, and a fan (376) for providing a flow of cooling air along the air path. An end unit (330) is removably coupled to the housing and has second openings (332). A second control circuit (384) is disposed in the end unit, and electrically coupled to and substantially thermally isolated from the first control circuit. The lighting assembly is configured to direct the flow of the cooling air toward the at least one first control circuit so as to effectively remove heat.

### TECHNICAL FIELD

The present invention is directed generally to illumination, and in particular, to the implementation and control of LED-based lighting fixtures for stage lighting applications.

### BACKGROUND

Lighting fixtures have been used for many years for set and stage illumination in various theater, television, and architectural lighting applications. Typically, each fixture includes an incandescent lamp mounted adjacent to a concave reflector, which reflects light through a lens assembly to project a beam of light toward a theater stage or the like. A color filter may be mounted at the fixture's forward end, to transmit selected wavelengths of the light emitted by the lamp, while absorbing and/or reflecting other wavelengths. This provides the projected beam with a particular spectral composition.

Color filters (also commonly referred to as “gels”) used in such lighting fixtures typically comprise glass or plastic films, e.g., of polyester or polycarbonate, carrying a dispersed chemical dye. The dyes transmit certain wavelengths of light, while absorbing other wavelengths. Several hundred different colors can be provided by such filters, and some of these colors have been widely accepted as standard colors in the industry.

Although generally effective, such plastic color filters typically have limited lifetimes, due to their need to dissipate large amounts of heat derived from the absorbed wavelengths. This has been a particular problem for filters transmitting blue and green wavelengths. Further, although the variety of colors that may be realized by color filters is large, the selection of colors is nevertheless limited by the availability of commercial dyes and the compatibility of those dyes with the glass or plastic substrates. In addition, the very mechanism of absorbing non-selected wavelengths is inherently inefficient, in that substantial energy is lost to heat.

In some lighting applications, gas discharge lamps have been substituted for the incandescent lamps, and dichroic filters have been substituted for the color filters. Such dichroic filters typically have the form of a glass substrate carrying a multi-layer dichroic coating, which reflects certain wavelengths and transmits the remaining wavelengths. These alternative lighting fixtures generally have improved efficiency, and their dichroic filters are not subject to fading or other degradation caused by overheating. However, the dichroic filters offer only limited control of color, and the fixtures cannot replicate many of the complex colors created by the absorptive filters that have been accepted as industry standards.

In some lighting applications, it is often desirable to change the color of the light being produced by a particular lighting fixture. Accordingly, several remotely operated color-changing devices have been developed in recent years. One such device is a color scroller, which includes a scroll typically containing 16 preselected absorptive color filters. The filters in color scrollers are subject to the same problems of fading and deformation as are the individual absorptive filters. Another such device is a dichroic color wheel, which includes a rotatable wheel carrying preselected dichroic coatings. These color wheels avoid the noted problems of fading and deformation, but are able to carry fewer colors (typically about eight) and are substantially more expensive than a color scroller.

Digital lighting technologies, i.e., illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g., red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

Recently, some lighting fixtures have substituted LEDs for incandescent lamps and gas-discharge lamps. Equal quantities of red-, green-, and blue-colored LEDs typically have been used, arranged in a suitable array. Some LED fixtures have further included an equal quantity of amber-colored LEDs. By providing electrical power in selected amounts to these LEDs, typically using pulse-width modulated electrical current, light having a variety of colors can be projected. These fixtures eliminate the need for color filters, thereby improving on the efficiency of prior fixtures incorporating incandescent lamps or gas-discharge lamps.

Lighting fixtures incorporating red-, green-, and blue-colored LEDs, i.e., RGB LED fixtures, can project beams of light having an apparent color of white, especially when illuminating a white or other fully reflective surface. However, the actual spectrum of this apparent white color is not at all the same as that of the white light provided by fixtures incorporating incandescent lamps. This is because LEDs emit light in narrow wavelength bands, and the combined light output from three different LED colors is insufficient to cover the full visible spectrum. Colored objects illuminated by such RGB LED fixtures frequently do not appear in their true colors. For example, an object that reflects only yellow light, and thus that appears to be yellow when illuminated with white light, will appear black when illuminated with light having an apparent yellow color, produced by the red and green LEDs of an RGB LED fixture. Such fixtures, therefore, are considered to provide poor color rendition when illuminating a setting such as a theater stage, television set, building interior, or display window. A limited number of LED lighting fixtures have included not only LEDs emitting red, green, and blue light, but also LEDs emitting amber light. Such fixtures are sometimes called RGBA LED fixtures. These fixtures are subject to the same drawbacks as are RGB LED fixtures, but to a slightly reduced degree.

### SUMMARY

It should be apparent from the foregoing description that there is a need for improved lighting apparatus and methods, suitable for use in a lighting fixture, involving individually-colored light sources, e.g., LEDs, that improve on the power efficiency of fixtures incorporating incandescent lamps and gas-discharge lamps, yet may produce beams of light having luminous flux spectra that can be more precisely controlled and, further, that can closely emulate the spectra of prior lighting fixtures and thus provide improved color rendition.

In view of the foregoing, various aspects and embodiments of the present invention are direct to method and apparatus for providing LED-based theatrical illumination. In one exemplary implementation a theatrical lighting fixture improves heat dissipation and employs LED-based light sources for producing spectral profiles that are useful in a variety of applications, including theater lighting. Other aspects of the present invention relate to methods for providing spectral profiles useful for said variety of applications.

For example, in one aspect, the invention is directed to a modular lighting fixture for providing theatrical illumination. The lighting fixture comprises an essentially cylindrically-shaped housing, the housing including at least one first opening for providing an air path through the lighting fixture. The fixture further comprises an LED-based lighting assembly disposed in the housing, wherein the LED-based lighting assembly comprises an LED module including a plurality of LED light sources having different colors and/or different color temperatures and disposed on a printed circuit board, at least one first control circuit for controlling the plurality of LED light sources, and at least one fan for providing a flow of cooling air along the air path through the lighting fixture. The fixture further comprises an end unit removably coupled to the housing, the end unit including at least one second opening for providing the air path through the lighting fixture, and at least one second control circuit disposed in the end unit, the at least one second control circuit electrically coupled to and substantially thermally isolated from the at least one first control circuit. The LED-based lighting assembly is configured to direct the flow of the cooling air toward the at least one first control circuit so as to effectively remove heat generated by at least the at least one first control circuit.

In other aspects, the at least one first control circuit comprises at least one power supply circuit board and at least one driver circuit board. In yet other aspects, the LED-based lighting assembly further comprises a heat sink coupled to the LED module, the heat sink including a plurality of fins substantially aligned with the at least one first opening in the housing, a shroud disposed proximate to the heat sink and configured to direct the flow of the cooling air toward the at least one power supply circuit board and the at least one driver circuit board, and a mounting plate (374) for mounting at least the at least one power supply circuit board and the at least one driver circuit board, the mounting plate having an aperture for providing the air path through the lighting fixture.

Yet another aspect of the present invention is directed to a method for providing theatrical illumination from a lighting fixture including a plurality of LED light sources having different colors and/or color temperatures. The method comprises: A) receiving at least one input signal representing a desired output color or color temperature for the illumination; and B) processing the at least one input signal so as to provide at least one control signal representing a lighting command including an n-tuple of channel values, wherein the n-tuple of channel values includes one value for each different color or color temperature of the plurality of LED light sources.

In one exemplary implementation, the at least one input signal includes a representation of the desired output color in a multi-dimensional color space, and B) comprises: mapping the representation of the desired output color in the multi-dimensional color space to the lighting command including the n-tuple of channel values. In another exemplary implementation, the at least one input signal includes a representation of the desired output color in the form of a <source, filter> pair defining a source spectrum and gel filter color, and B) comprises: mapping the <source, filter> pair to the lighting command including the n-tuple of channel values.

As used herein for purposes of the present invention, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like.

In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K. has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present invention include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present invention, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present invention include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a diagram illustrating a controllable LED-based lighting unit that provides a conceptual basis for various embodiments of the present invention.

FIG. 2 is a diagram illustrating a networked system of multiple LED-based lighting units of FIG. 1.

FIG. 3A illustrates a lighting fixture according to one embodiment of the present invention.

FIG. 3B illustrates a partial, exploded view of the lighting fixture of FIG. 3A with one-half of the housing removed.

FIG. 3C illustrates an exploded view of an LED-based lighting assembly of the lighting fixture shown in FIGS. 3A-3B, according to one embodiment of the present invention.

FIG. 3D is a block diagram schematically illustrating the flow of power and data among various components of the LED-based lighting assembly of FIG. 3C according to one embodiment of the present invention.

FIG. 3E schematically illustrates an LED module of the lighting fixture of FIGS. 3A-3C.

FIG. 3F is an exploded view of a back end of the lighting fixture of FIGS. 3A-3B, including various components housed therein, according to one embodiment of the present invention.

FIGS. 4A and 4B illustrate a perspective and cross-sectional view, respectively, of a collimator for use with the LED module shown in FIG. 3E, according to one embodiment of the present invention.

FIGS. 4C and 4D illustrate a top and perspective view, respectively, of a holder for the collimator of FIGS. 4A and 4B according to one embodiment of the present invention.

### DETAILED DESCRIPTION

Various implementations of the present invention and related inventive concepts are described below, including certain embodiments relating particularly to LED-based light sources. It should be appreciated, however, that the present invention is not limited to any particular manner of implementation, and that the various embodiments discussed explicitly herein are provided primarily for purposes of illustration. For example, the various concepts discussed herein may be suitably implemented in a variety of environments involving LED-based light sources, other types of light sources not including LEDs, environments that involve both LEDs and other types of light sources in combination, and environments that involve non-lighting-related devices alone or in combination with various types of light sources.

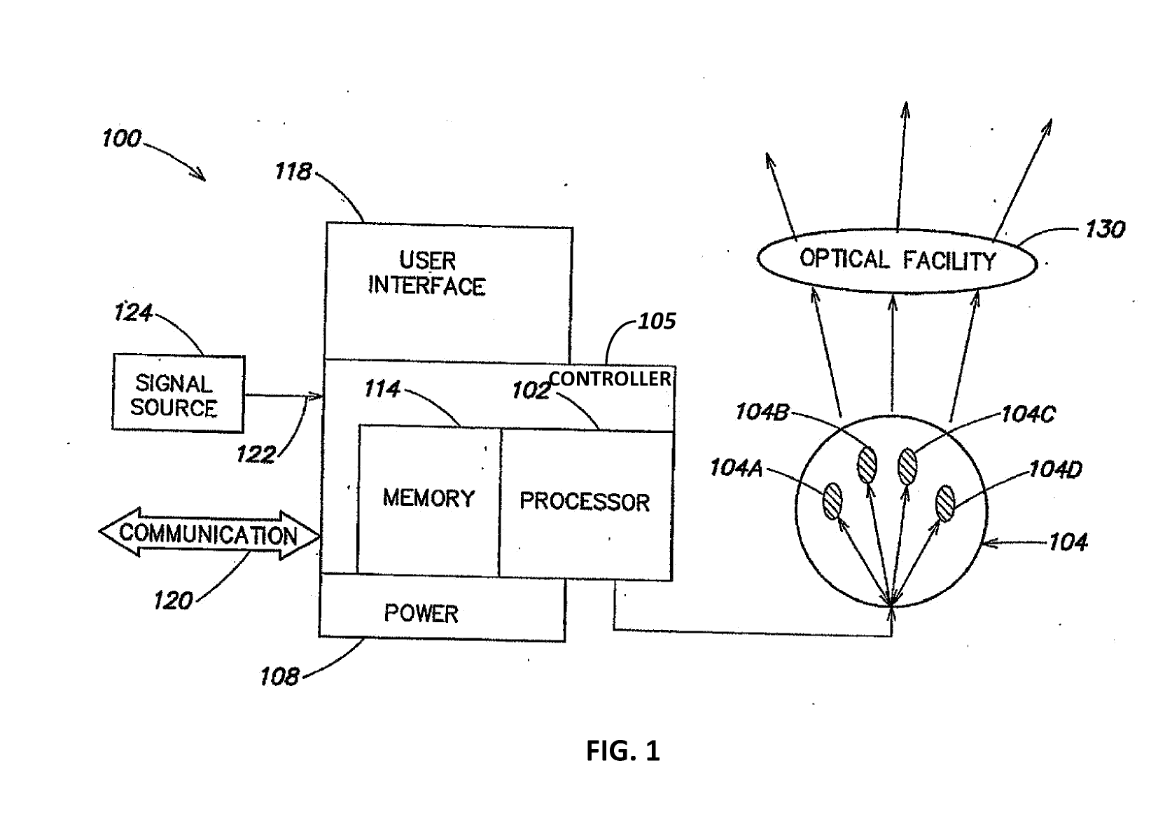

FIG. 1 illustrates one example of a controllable LED-based lighting unit 100 that provides a conceptual basis for various embodiments of the present invention. Some general examples of LED-based lighting units similar to those that are described below in connection with FIG. 1 may be found, for example, in U.S. Pat. No. 6,016,038, issued Jan. 18, 2000 to Mueller et al., entitled “Multicolored LED Lighting Method and Apparatus,” and U.S. Pat. No. 6,211,626, issued Apr. 3, 2001 to Lys et al, entitled “Illumination Components,” which patents are both hereby incorporated herein by reference.

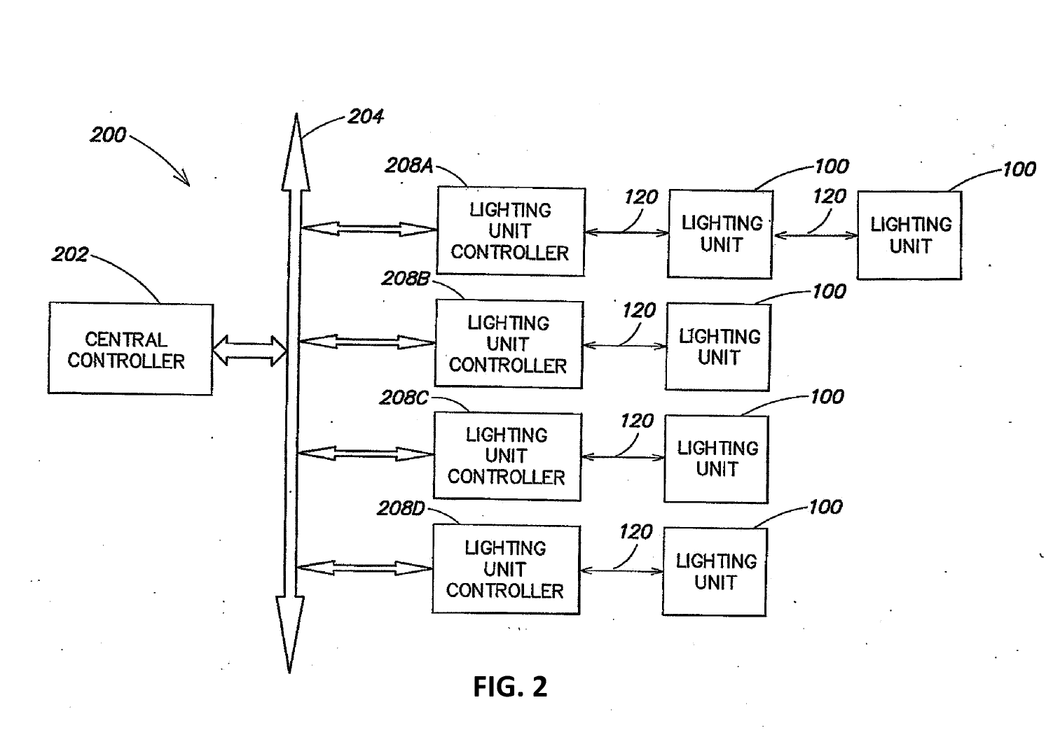

In various implementations, the lighting unit 100 shown in FIG. 1 may be used alone or together with other similar lighting units in a system of lighting units (e.g., as discussed further below in connection with FIG. 2). Used alone or in combination with other lighting units, the lighting unit 100 may be employed in a variety of applications including, but not limited to, direct-view or indirect-view interior or exterior space (e.g., architectural) lighting and illumination in general, direct or indirect illumination of objects or spaces, and theatrical or other entertainment-based/special effects lighting.

The lighting unit 100 may include one or more light sources 104A, 104B, 104C, and 104D (shown collectively as 104), wherein one or more of the light sources may be an LED-based light source that includes one or more LEDs. Any two or more of the light sources may be adapted to generate radiation of different colors (e.g. red, green, blue); in this respect, as discussed above, each of the different color light sources generates a different source spectrum that constitutes a different “channel” of a “multi-channel” lighting unit. Although FIG. 1 shows four light sources 104A, 104B, 104C, and 104D, it should be appreciated that the lighting unit is not limited in this respect, as different numbers and various types of light sources (all LED-based light sources, LED-based and non-LED-based light sources in combination, etc.) adapted to generate radiation of a variety of different colors, including essentially white light, may be employed in the light source 104, as discussed further below.

Lighting unit 100 also may include a controller 105 that is configured to output one or more control signals to drive the light sources so as to generate various intensities of light from the light sources. For example, in one implementation, the controller 105 may be configured to output at least one control signal for each light source so as to independently control the intensity of light (e.g., radiant power in lumens) generated by each light source; alternatively, the controller 105 may be configured to output one or more control signals to collectively control a group of two or more light sources identically. Some examples of control signals that may be generated by the controller to control the light sources include, but are not limited to, pulse modulated signals, pulse width modulated signals (PWM), pulse amplitude modulated signals (PAM), pulse code modulated signals (PCM) analog control signals (e.g., current control signals), voltage control signals), combinations and/or modulations of the foregoing signals, or other control signals. In some implementations, particularly in connection with LED-based sources, one or more modulation techniques provide for variable control using a fixed current level applied to one or more LEDs, so as to mitigate potential undesirable or unpredictable variations in LED output that may arise if a variable LED drive current were employed. In other implementations, the controller 105 may control other dedicated circuitry (not shown in FIG. 1) which in turn controls the light sources so as to vary their respective intensities.

In general, the intensity (radiant output power) of radiation generated by the one or more light sources is proportional to the average power delivered to the light source(s) over a given time period. Accordingly, one technique for varying the intensity of radiation generated by the one or more light sources involves modulating the power delivered to (i.e., the operating power of) the light source(s). For some types of light sources, including LED-based sources, this may be accomplished effectively using a pulse width modulation (PWM) technique.

In one exemplary implementation of a PWM control technique, for each channel of a lighting unit a fixed predetermined voltage V_{source} is applied periodically across a given light source constituting the channel. The application of the voltage V_{source} may be accomplished via one or more switches, not shown in FIG. 1, controlled by the controller 105. While the voltage V_{source} is applied across the light source, a predetermined fixed current I_{source} (e.g., determined by a current regulator, also not shown in FIG. 1) is allowed to flow through the light source. Again, recall that an LED-based light source may include one or more LEDs, such that the voltage V_{source} may be applied to a group of LEDs constituting the source, and the current I_{source} may be drawn by the group of LEDs. The fixed voltage V_{source} across the light source when energized, and the regulated current I_{source} drawn by the light source when energized, determines the amount of instantaneous operating power P_{source} of the light source (P_{source}=V_{source}·I_{source}). As mentioned above, for LED-based light sources, using a regulated current mitigates potential undesirable or unpredictable variations in LED output that may arise if a variable LED drive current were employed.

According to the PWM technique, by periodically applying the voltage V_{source} to the light source and varying the time the voltage is applied during a given on-off cycle, the average power delivered to the light source over time (the average operating power) may be modulated. In particular, the controller 105 may be configured to apply the voltage V_{source} to a given light source in a pulsed fashion (e.g., by outputting a control signal that operates one or more switches to apply the voltage to the light source), preferably at a frequency that is greater than that capable of being detected by the human eye (e.g., greater than approximately 100 Hz). In this manner, an observer of the light generated by the light source does not perceive the discrete on-off cycles (commonly referred to as a “flicker effect”), but instead the integrating function of the eye perceives essentially continuous light generation. By adjusting the pulse width (i.e. on-time, or “duty cycle”) of on-off cycles of the control signal, the controller varies the average amount of time the light source is energized in any given time period, and hence varies the average operating power of the light source. In this manner, the perceived brightness of the generated light from each channel in turn may be varied.

As discussed in greater detail below, the controller 105 may be configured to control each different light source channel of a multi-channel lighting unit at a predetermined average operating power to provide a corresponding radiant output power for the light generated by each channel. Alternatively, the controller 105 may receive instructions (e.g., “lighting commands”) from a variety of origins, such as a user interface 118, a signal source 124, or one or more communication ports 120, that specify prescribed operating powers for one or more channels and, hence, corresponding radiant output powers for the light generated by the respective channels. By varying the prescribed operating powers for one or more channels (e.g., pursuant to different instructions or lighting commands), different perceived colors and brightness levels of light may be generated by the lighting unit.

In some implementations of lighting unit 100, as mentioned above, one or more of the light sources 104A, 104B, 104C, and 104D shown in FIG. 1 may include a group of multiple LEDs or other types of light sources (e.g., various parallel and/or serial connections of LEDs or other types of light sources) that are controlled together by the controller 105. Additionally, it should be appreciated that one or more of the light sources may include one or more LEDs that are adapted to generate radiation having any of a variety of spectra (i.e., wavelengths or wavelength bands), including, but not limited to, various visible colors (including essentially white light), various color temperatures of white light, ultraviolet, or infrared. LEDs having a variety of spectral bandwidths (e.g., narrow band, broader band) may be employed in various implementations of lighting unit 100.

Lighting unit 100 may be constructed and arranged to produce a wide range of variable color radiation. For example, in one implementation, lighting unit 100 may be particularly arranged such that controllable variable intensity (i.e., variable radiant power) light generated by two or more of the light sources combines to produce a mixed colored light (including essentially white light having a variety of color temperatures). In particular, the color (or color temperature) of the mixed colored light may be varied by varying one or more of the respective intensities (output radiant power) of the light sources (e.g., in response to one or more control signals output by the controller 105). Furthermore, the controller 105 may be particularly configured to provide control signals to one or more of the light sources so as to generate a variety of static or time-varying (dynamic) multi-color (or multi-color temperature) lighting effects. To this end, the controller 105 may include a processor 102 (e.g., a microprocessor) programmed to provide such control signals to one or more of the light sources. In various implementations, the processor 102 may be programmed to provide such control signals autonomously, in response to lighting commands, or in response to various user or signal inputs.

Thus, lighting unit 100 may include a variety of colors of LEDs in various combinations, including two or more of red, green, and blue LEDs to produce a color mix, as well as one or more other LEDs to create varying colors and/or color temperatures of white light. For example, red, green and blue can be mixed with amber, white, UV, orange, IR or other colors of LEDs. Additionally, multiple white LEDs having different color temperatures (e.g., one or more first white LEDs that generate a first spectrum corresponding to a first color temperature, and one or more second white LEDs that generate a second spectrum corresponding to a second color temperature different than the first color temperature) may be employed, in an all-white LED lighting unit or in combination with other colors of LEDs. Such combinations of differently colored LEDs and/or different color temperature white LEDs in lighting unit 100 may facilitate an accurate reproduction of a host of desirable spectrums of lighting conditions, examples of which include, but are not limited to, a variety of outside daylight equivalents at different times of the day, various interior lighting conditions, lighting conditions to simulate a complex multicolored background, and the like. Other desirable lighting conditions can be created by removing particular pieces of spectrum that may be specifically absorbed, attenuated or reflected in certain environments. Water, for example tends to absorb and attenuate most non-blue and non-green colors of light, so underwater applications may benefit from lighting conditions that are tailored to emphasize or attenuate some spectral elements relative to others.

As shown in FIG. 1, lighting unit 100 also may include a memory 114 to store various data. For example, the memory 114 may be employed to store one or more lighting commands or programs for execution by the processor 102 (e.g., to generate one or more control signals for the light sources), as well as various types of data useful for generating variable color radiation (e.g., calibration information, discussed further below). The memory 114 also may store one or more particular identifiers (e.g., a serial number, an address, etc.) that may be used either locally or on a system level to identify lighting unit 100. In various embodiments, such identifiers may be pre-programmed by a manufacturer, for example, and may be either alterable or non-alterable thereafter (e.g., via some type of user interface located on the lighting unit, via one or more data or control signals received by the lighting unit, etc.). Alternatively, such identifiers may be determined at the time of initial use of the lighting unit in the field, and again may be alterable or non-alterable thereafter.

One issue that may arise in connection with controlling multiple light sources in lighting unit 100 and controlling multiple lighting units 100 in a lighting system (e.g., as discussed below in connection with FIG. 2), relates to potentially perceptible differences in light output between substantially similar light sources. For example, given two virtually identical light sources being driven by respective identical control signals, the actual intensity of light (e.g., radiant power in lumens) output by each light source may be measurably different. Such a difference in light output may be attributed to various factors including, for example, slight manufacturing differences between the light sources, normal wear and tear over time of the light sources that may differently alter the respective spectrums of the generated radiation, etc. For purposes of the present discussion, light sources for which a particular relationship between a control signal and resulting output radiant power are not known are referred to as “uncalibrated” light sources. The use of one or more uncalibrated light sources in lighting unit 100 may result in generation of light having an unpredictable, or “uncalibrated,” color or color temperature. For example, consider a first lighting unit including a first uncalibrated red light source and a first uncalibrated blue light source, each controlled in response to a corresponding lighting command having an adjustable parameter in a range of from zero to 255 (0-255), wherein the maximum value of 255 represents the maximum radiant power available (i.e., 100%) from the light source. For purposes of this example, if the red command is set to zero and the blue command is non-zero, blue light is generated, whereas if the blue command is set to zero and the red command is non-zero, red light is generated. However, if both commands are varied from non-zero values, a variety of perceptibly different colors may be produced (e.g., in this example, at very least, many different shades of purple are possible). In particular, perhaps a particular desired color (e.g., lavender) is given by a red command having a value of 125 and a blue command having a value of 200. Now consider a second lighting unit including a second uncalibrated red light source substantially similar to the first uncalibrated red light source of the first lighting unit, and a second uncalibrated blue light source substantially similar to the first uncalibrated blue light source of the first lighting unit. As discussed above, even if both of the uncalibrated red light sources are controlled in response to respective identical commands, the actual intensity of light (e.g., radiant power in lumens) output by each red light source may be measurably different. Similarly, even if both of the uncalibrated blue light sources are controlled in response to respective identical commands, the actual light output by each blue light source may be measurably different.

With the foregoing in mind, it should be appreciated that if multiple uncalibrated light sources are used in combination in lighting units to produce a mixed colored light as discussed above, the observed color (or color temperature) of light produced by different lighting units under identical control conditions may be perceivably different. Specifically, consider again the “lavender” example above; the “first lavender” produced by the first lighting unit with a red command having a value of 125 and a blue command having a value of 200 indeed may be perceivably different than a “second lavender” produced by the second lighting unit with a red command having a value of 125 and a blue command having a value of 200. More generally, the first and second lighting units generate uncalibrated colors by virtue of their uncalibrated light sources. Accordingly, in some implementations of the present invention, lighting unit 100 includes a calibration system to facilitate the generation of light having a calibrated (e.g., predictable, reproducible) color at any given time. In one aspect, a calibration system may be configured to adjust (e.g., scale) the light output of at least some light sources of the lighting unit so as to compensate for perceptible differences between similar light sources used in different lighting units. For example, in one embodiment, the processor 102 of lighting unit 100 is configured to control one or more of the light sources so as to output radiation at a calibrated intensity that substantially corresponds in a predetermined manner to a control signal for the light source(s). As a result of mixing radiation having different spectra and respective calibrated intensities, a calibrated color is produced. In one aspect of this embodiment, at least one calibration value for each light source is stored in the memory 114, and the processor is programmed to apply the respective calibration values to the control signals (commands) for the corresponding light sources so as to generate the calibrated intensities. One or more calibration values may be determined once (e.g., during a lighting unit manufacturing/testing phase) and stored in the memory 114 for use by the processor 102. In another aspect, the processor 102 may be configured to derive one or more calibration values dynamically (e.g. from time to time) with the aid of one or more photosensors, for example. In various embodiments, the photosensor(s) may be one or more external components coupled to the lighting unit, or alternatively may be integrated as part of the lighting unit itself. A photosensor is one example of a signal source that may be integrated or otherwise associated with lighting unit 100, and monitored by the processor 102 in connection with the operation of the lighting unit. Other examples of such signal sources are discussed further below, in connection with the signal source 124 shown in FIG. 1. One exemplary method that may be implemented by the processor 102 to derive one or more calibration values includes applying a reference control signal to a light source (e.g., corresponding to maximum output radiant power), and measuring (e.g., via one or more photosensors) an intensity of radiation (e.g., radiant power falling on the photosensor) thus generated by the light source. The processor may be programmed to compare the measured intensity and at least one reference value (e.g., representing an intensity that nominally would be expected in response to the reference control signal). Based on such a comparison, the processor may determine one or more calibration values (e.g., scaling factors) for the light source. In particular, the processor may derive a calibration value such that, when applied to the reference control signal, the light source outputs radiation having an intensity that corresponds to the reference value (i.e., an “expected” intensity, e.g., expected radiant power in lumens). In various aspects, one calibration value may be derived for an entire range of control signal/output intensities for a given light source. Alternatively, multiple calibration values may be derived for a given light source (i.e., a number of calibration value “samples” may be obtained) that are respectively applied over different control signal/output intensity ranges, to approximate a nonlinear calibration function in a piecewise linear manner.

In some embodiments, lighting unit 100 may also include one or more user interfaces 118 that are provided to facilitate any of a number of user-selectable settings or functions (e.g., generally controlling the light output of lighting unit 100, changing and/or selecting various pre-programmed lighting effects to be generated by the lighting unit, changing and/or selecting various parameters of selected lighting effects, setting particular identifiers such as addresses or serial numbers for the lighting unit, etc.). In various embodiments, communication between the user interface 118 and the lighting unit may be accomplished through a wire, cable, or wireless transmission.

In one implementation, the controller 105 of the lighting unit monitors the user interface 118 and controls one or more of the light sources 104A, 104B, 104C and 104D based at least in part on a user's operation of the interface. For example, the controller 105 may be configured to respond to operation of the user interface by originating one or more control signals for controlling one or more of the light sources. Alternatively, the processor 102 may be configured to respond by selecting one or more pre-programmed control signals stored in memory, modifying control signals generated by executing a lighting program, selecting and executing a new lighting program from memory, or otherwise affecting the radiation generated by one or more of the light sources.

In particular, in one implementation, the user interface 118 may constitute one or more switches (e.g., a standard wall switch) that interrupt power to the controller 105. In one aspect of this implementation, the controller 105 is configured to monitor the power as controlled by the user interface, and in turn control one or more of the light sources based at least in part on a duration of a power interruption caused by operation of the user interface. As discussed above, the controller may be particularly configured to respond to a predetermined duration of a power interruption by, for example, selecting one or more pre-programmed control signals stored in memory, modifying control signals generated by executing a lighting program, selecting and executing a new lighting program from memory, or otherwise affecting the radiation generated by one or more of the light sources.

FIG. 1 also illustrates that lighting unit 100 may be configured to receive one or more signals 122 from one or more other signal sources 124. In one implementation, the controller 105 of the lighting unit may use the signal(s) 122, either alone or in combination with other control signals (e.g., signals generated by executing a lighting program, one or more outputs from a user interface, etc.), so as to control one or more of the light sources 104A, 104B, 104C and 104D in a manner similar to that discussed above in connection with the user interface 118.

Examples of the signal(s) 122 that may be received and processed by the controller 105 include, but are not limited to, one or more audio signals, video signals, power signals, various types of data signals, signals representing information obtained from a network (e.g., the Internet), signals representing one or more detectable/sensed conditions, signals from lighting units, signals consisting of modulated light, etc. In various implementations, the signal source(s) 124 may be located remotely from lighting unit 100, or included as a component of the lighting unit. In one embodiment, a signal from one lighting unit 100 may be transmitted over a network to another lighting unit.

Some examples of a signal source 124 that may be employed in, or used in connection with, lighting unit 100 include any of a variety of sensors or transducers that generate one or more output signals 122 in response to a stimulus. Examples of such sensors include, but are not limited to, various types of environmental condition sensors, such as thermally sensitive (e.g., temperature, infrared) sensors, humidity sensors, motion sensors, photosensors/light sensors (e.g., photodiodes, sensors that are sensitive to one or more particular spectra of electromagnetic radiation such as spectroradiometers or spectrophotometers, etc.), various types of cameras, sound or vibration sensors or other pressure/force transducers (e.g., microphones, piezoelectric devices), and the like.

Additional examples of a signal source 124 include various metering/detection devices that monitor electrical signals or characteristics (e.g., voltage, current, power, resistance, capacitance, inductance, etc.) or chemical/biological characteristics (e.g., acidity, a presence of one or more particular chemical or biological agents, bacteria, etc.) and provide one or more output signals 122 based on measured values of the signals or characteristics. Yet other examples of a signal source 124 include various types of scanners, image recognition systems, voice or other sound recognition systems, artificial intelligence and robotics systems, and the like. A signal source 124 could also be a lighting unit 100, another controller or processor, or any one of many available signal generating devices, such as media players, MP3 players, computers, DVD players, CD players, television signal sources, camera signal sources, microphones, speakers, telephones, cellular phones, instant messenger devices, SMS devices, wireless devices, personal organizer devices, and many others.

In some embodiments, lighting unit 100 may include one or more optical elements or facilities 130 to process the radiation generated by the light sources 104A, 104B, 104C, and 104D. For example, one or more optical elements 130 may be configured so as to change one or both of a spatial distribution and a propagation direction of the generated radiation (e.g., in response to some electrical and/or mechanical stimulus). In particular, one or more optical elements may be configured to change a diffusion angle of the generated radiation. Examples of optical elements that may be included in lighting unit 100 include, but are not limited to, reflective materials, refractive materials, translucent materials, filters, lenses, mirrors, and fiber optics. The one or more optical elements 130 may also include a phosphorescent material, luminescent material, or other material capable of responding to or interacting with the generated radiation.

In some embodiments, lighting unit 100 may include one or more communication ports 120 to facilitate coupling of lighting unit 100 to any of a variety of other devices, including one or more other lighting units. For example, one or more communication ports 120 may facilitate coupling multiple lighting units together as a networked lighting system, in which at least some or all of the lighting units are addressable (e.g., have particular identifiers or addresses) and/or are responsive to particular data transported across the network. In another aspect, one or more communication ports 120 may be adapted to receive and/or transmit data through wired or wireless transmission. In one embodiment, information received through a communication port 120 may at least in part relate to address information to be subsequently used by the lighting unit, and the lighting unit may be adapted to receive and store the address information in the memory 114 (e.g., the lighting unit may be adapted to use the stored address as its address for use when receiving subsequent data via one or more communication ports).

In particular, in a networked lighting system environment, as discussed in greater detail further below (e.g., in connection with FIG. 2), as data is communicated via the network, the controller 105 of each lighting unit coupled to the network may be configured to be responsive to particular data (e.g., lighting control commands) that pertain to it (e.g., in some cases, as dictated by the respective identifiers of the networked lighting units). Once a given controller identifies particular data intended for it, it may read the data and, for example, change the lighting conditions produced by its light sources according to the received data (e.g., by generating appropriate control signals to the light sources). In one aspect, the memory 114 of each lighting unit coupled to the network may be loaded with a table of lighting control signals that correspond to data received by the processor 102. Once the processor 102 receives data from the network, the processor may consult the table to select the control signals that correspond to the received data, and control the light sources of the lighting unit accordingly (e.g., using any one of a variety of analog or digital signal control techniques, including various pulse modulation techniques discussed above).

In one aspect, the processor 102 of a given lighting unit, whether or not coupled to a network, may be configured to interpret lighting instructions/data that are received according to a DMX protocol (as discussed, for example, in U.S. Pat. Nos. 6,016,038 and 6,211,626). DMX is a lighting command protocol conventionally employed in the lighting industry for some programmable lighting applications. In the DMX protocol, lighting instructions are transmitted to a lighting unit as control data that is formatted into “packets” that include 512 bytes of data, wherein each data byte constitutes 8-bits which represent a digital value of between zero and 255. These 512 data bytes are typically preceded by a “start code” byte. In an exemplary DMX implementation, an entire packet including 513 bytes (start code plus data) is transmitted serially at 250 kbit/s pursuant to RS-485 voltage levels and cabling practices, wherein the start of a packet is signified by a break of at least 88 microseconds.

In the DMX protocol, each data byte of the 512 bytes in a given packet is intended as a lighting command for a particular “channel” of a multi-channel lighting unit, wherein a digital value of zero indicates no radiant output power for a given channel of the lighting unit (i.e., channel off), and a digital value of 255 indicates full radiant output power (100% available power) for the given channel of the lighting unit (i.e., channel full on). For example, in one aspect, considering for the moment a three-channel lighting unit based on red, green and blue LEDs (i.e., an “R-G-B” lighting unit), a lighting command in a DMX protocol may specify each of a red channel command, a green channel command, and a blue channel command as eight-bit data (i.e., a data byte) representing a value from 0 to 255. The maximum value of 255 for any one of the color channels instructs the processor 102 to control the corresponding light source(s) to operate at maximum available power (i.e., 100%) for the channel, thereby generating the maximum available radiant power for that color (such a command structure for an R-G-B lighting unit commonly is referred to as 24-bit color control). Hence, a command of the format [R, G, B]=[255, 255, 255] would cause the lighting unit to generate maximum radiant power for each of red, green and blue light (thereby creating white light).

A communication link employing the DMX protocol typically may support up to 512 different lighting unit channels, and a given lighting unit designed to receive communications formatted in the DMX protocol may be configured to respond to only one or more particular data bytes of the 512 bytes in the packet corresponding to the number of channels of the lighting unit (e.g., in the example of a three-channel lighting unit, three bytes are used by the lighting unit). The particular data byte(s) of interest for a particular lighting unit may be determined based on their position in the overall sequence of the 512 data bytes in the packet. To this end, DMX-based lighting units may be equipped with an address selection mechanism that may be configured to determine the particular position of the data byte(s) that the lighting unit responds to in a given DMX packet.

It should be appreciated, however, that lighting units suitable for use with embodiments of the present invention are not limited to using a DMX command format, as lighting units according to various embodiments may be configured to be responsive to other types of communication protocols/lighting command formats so as to control their respective light sources. In general, the processor 102 may be configured to respond to lighting commands in a variety of formats that express prescribed operating powers for each different channel of a multi-channel lighting unit according to some scale representing zero to maximum available operating power for each channel.

For example, in some embodiments, the processor 102 of a given lighting unit may be configured to interpret lighting instructions/data that are received in a conventional Ethernet protocol (or similar protocol based on Ethernet concepts). Ethernet is a well-known computer networking technology often employed for local area networks (LANs) that defines wiring and signaling requirements for interconnected devices forming the network, as well as frame formats and protocols for data transmitted over the network. Devices coupled to the network have respective unique addresses, and data for one or more addressable devices on the network is organized as packets. Each Ethernet packet includes a “header” that specifies a destination address and a source address followed by a “payload” including several bytes of data (e.g., in Type II Ethernet frame protocol, the payload may be from 46 data bytes to 1500 data bytes). A packet concludes with an error correction code or “checksum.” Similar to the DMX protocol discussed above, the payload of successive Ethernet packets destined for a given lighting unit configured to receive communications in an Ethernet protocol may include information that represents respective prescribed radiant powers for different available spectra of light (e.g., different color channels) capable of being generated by the lighting unit.

In yet other embodiments, the processor 102 of a given lighting unit may be configured to interpret lighting instructions/data that are received in a serial-based communication protocol as described, for example, in U.S. Pat. No. 6,777,891. In particular, according to one embodiment based on a serial-based communication protocol, multiple lighting units 100 are coupled together via one or more communication ports 120 to form a series connection of lighting units (e.g., a daisy-chain or ring topology), wherein each lighting unit has an input communication port and an output communication port. Lighting instructions/data transmitted to the lighting units may be arranged sequentially based on a relative position in the series connection of each lighting unit. It should be appreciated that while a lighting network based on a series interconnection of lighting units is discussed particularly in connection with an embodiment employing a serial-based communication protocol, the invention is not limited in this respect, as other examples of lighting network topologies contemplated by the present invention are discussed further below in connection with FIG. 2.

In one embodiment employing a serial-based communication protocol, as the processor 102 of each lighting unit in the series connection receives data, it “strips off” or extracts one or more initial portions of the data sequence intended for it and transmits the remainder of the data sequence to the next lighting unit in the series connection. For example, again considering a serial interconnection of multiple three-channel (e.g., “R-G-B”) lighting units, three multi-bit values (one multi-bit value per channel) may be extracted by each three-channel lighting unit from the received data sequence. Each lighting unit in the series connection in turn may repeat this procedure, namely, stripping off or extracting one or more initial portions (multi-bit values) of a received data sequence and transmitting the remainder of the sequence. The initial portion of a data sequence stripped off in turn by each lighting unit may include respective prescribed radiant powers for different available spectra of light (e.g., different color channels) capable of being generated by the lighting unit. As discussed above in connection with the DMX protocol, in various implementations, each multi-bit value per channel may be an 8-bit value, or other number of bits (e.g., 12, 16, 24, etc.) per channel, depending in part on a desired resolution for each channel.

In yet another exemplary implementation of a serial-based communication protocol, a flag may be associated with each portion of a data sequence representing data for multiple channels of a given lighting unit, and an entire data sequence for multiple lighting units may be transmitted completely from lighting unit to lighting unit in the serial connection. As a lighting unit in the serial connection receives the data sequence, it may search for a portion of the data sequence containing a flag that indicates that a given portion (representing one or more channels) has not yet been read by any lighting unit. Upon finding such a portion, the lighting unit may read and process the portion of the data sequence to provide a corresponding light output, thereafter setting the corresponding flag to indicate that the portion has been read. Thus, in this implementation, an entire data sequence may be transmitted from lighting unit to lighting unit, wherein the state of flags associated with the data sequence indicate the next portion of the data sequence available for reading and processing by the lighting units.

In another embodiment for use with a serial-based communication protocol, the controller 105 of a given lighting unit 100 configured for a serial-based communication protocol may be implemented as an application-specific integrated circuit (ASIC). The ASIC may be designed to specifically process a received stream of lighting instructions/data according to the “data stripping/extraction” process or “flag modification” process discussed above. For example, in one embodiment having multiple lighting units coupled together in a series connection to form a network, each lighting unit may include an ASIC-implemented controller 105 having a functionality previously described for the processor 102, the memory 114 and communication port(s) 120, as shown in FIG. 1 (optional user interface 118 and signal source 124 need not be included in some implementations). Such an embodiment is discussed in detail in U.S. Pat. No. 6,777,891.

In one embodiment, lighting unit 100 may include and/or be coupled to one or more power sources 108. In various aspects, examples of power source(s) 108 include, but are not limited to, AC power sources, DC power sources, batteries, solar-based power sources, thermoelectric or mechanical-based power sources and the like. Additionally, in one aspect, the power source(s) 108 may include or be associated with one or more power conversion devices or power conversion circuitry (e.g., in some cases internal to lighting unit 100) that convert power received by an external power source to a form suitable for operation of the various internal circuit components and light sources of lighting unit 100. In one exemplary implementation discussed in U.S. application Ser. Nos. 11/079,904 and 11,429,715, the controller 105 of lighting unit 100 may be configured to accept a standard A.C. line voltage from the power source 108 and provide appropriate D.C. operating power for the light sources and other circuitry of the lighting unit based on concepts related to DC-DC conversion, or “switching” power supply concepts. In one aspect of such implementations, the controller 105 may include circuitry to both accept a standard A.C. line voltage and ensure that power is drawn from the line voltage with a significantly high power factor.

A given lighting unit 100 also may have any one of a variety of mounting arrangements for the light source(s), enclosure/housing arrangements and shapes to partially or fully enclose the light sources, and/or electrical and mechanical connection configurations. In particular, in some implementations, a lighting unit may be configured as a replacement or “retrofit” to engage electrically and mechanically in a conventional socket or fixture arrangement (e.g., an Edison-type screw socket, a halogen fixture arrangement, a fluorescent fixture arrangement, etc.).

Additionally, one or more optical elements as discussed above may be partially or fully integrated with an enclosure/housing arrangement for the lighting unit. Furthermore, the various components of the lighting unit discussed above (e.g., processor, memory, power, user interface, etc.), as well as other components that may be associated with the lighting unit in different implementations (e.g., sensors/transducers, other components to facilitate communication to and from the unit, etc.) may be packaged in a variety of ways; for example, in one aspect, any subset or all of the various lighting unit components, as well as other components that may be associated with the lighting unit, may be packaged together. In another aspect, packaged subsets of components may be coupled together electrically and/or mechanically in a variety of manners.

FIG. 2 illustrates an example of a networked lighting system 200 according to one embodiment of the present invention. In the embodiment of FIG. 2, a number of lighting units 100, similar to those discussed above, are coupled together to form a networked lighting system. It should be appreciated, however, that the particular configuration and arrangement of lighting units shown in FIG. 2 is for purposes of illustration only, and that the invention is not limited to the particular system topology shown in FIG. 2.

Additionally, while not shown explicitly in FIG. 2, it should be appreciated that the networked lighting system 200 may be configured flexibly to include one or more user interfaces, as well as one or more signal sources such as sensors/transducers. For example, one or more user interfaces and/or one or more signal sources such as sensors/transducers (as discussed above in connection with FIG. 1) may be associated with any one or more of the lighting units of the networked lighting system 200. Alternatively (or in addition to the foregoing), one or more user interfaces and/or one or more signal sources may be implemented as “stand alone” components in the networked lighting system 200. Whether or not stand alone components are particularly associated with one or more lighting units 100, such components may be “shared” by the lighting units of the networked lighting system. Stated differently, one or more user interfaces and/or one or more signal sources such as sensors/transducers may constitute “shared resources” in the networked lighting system that may be used in connection with controlling any one or more of the lighting units of the system.

As shown in FIG. 2, the lighting system 200 may include one or more lighting unit controllers (hereinafter “LUCs”) 208A, 208B, 208C, and 208D, wherein each LUC is responsible for communicating with and generally controlling one or more lighting units 100 coupled to it. Although two lighting units 100 are shown in FIG. 2 as coupled to the LUC 208A, and one lighting unit 100 is coupled to each LUC 208B, 208C and 208D, it should be appreciated that the invention is not limited in this respect, as different numbers of lighting units 100 may be coupled to a given LUC in a variety of different configurations (e.g., serial connections, parallel connections, combinations of serial and parallel connections, etc.) using a variety of different communication media and protocols.

In some embodiments, each LUC may be coupled to a central controller 202 that is configured to communicate with one or more LUCs. Although FIG. 2 shows four LUCs coupled to the central controller 202 via a generic connection 204 (which may include any number of a variety of conventional coupling, switching and/or networking devices), it should be appreciated that according to various embodiments, different numbers of LUCs may be coupled to the central controller 202. Additionally, according to various embodiments of the present invention, the LUCs and the central controller may be coupled together in a variety of configurations using a variety of different communication media and protocols to form the networked lighting system 200. Moreover, it should be appreciated that the interconnection of LUCs and the central controller, and the interconnection of lighting units to respective LUCs, may be accomplished in any of a variety of ways (e.g., using different configurations, communication media, and protocols).

For example, according to one embodiment of the present invention, the central controller 202 may by configured to implement Ethernet-based communications with the LUCs, and in turn the LUCs may be configured to implement one of Ethernet-based, DMX-based, or serial-based protocol communications with lighting unit 100 (as discussed above, exemplary serial-based protocols suitable for various network implementation are discussed in detail in U.S. Pat. No. 6,777,891). In particular, in one aspect of this embodiment, each LUC may be configured as an addressable Ethernet-based controller and accordingly may be identifiable to the central controller 202 via a particular unique address (or a unique group of addresses and/or other identifiers) using an Ethernet-based protocol. In this manner, the central controller 202 may be configured to support Ethernet communications throughout the network of coupled LUCs, and each LUC may respond to those communications intended for it. In turn, each LUC may communicate lighting control information to one or more lighting units coupled to it, for example, via an Ethernet, DMX, or serial-based protocol, in response to the Ethernet communications with the central controller 202 (wherein the lighting units are appropriately configured to interpret information received from the LUC in the Ethernet, DMX, or serial-based protocols).

According to one embodiment, the LUCs 208A, 208B, and 208C may be configured to be “intelligent” in that the central controller 202 may be configured to communicate higher level commands to the LUCs that need to be interpreted by the LUCs before lighting control information can be forwarded to lighting units 100. For example, a lighting system operator may want to generate a color changing effect that varies colors from lighting unit to lighting unit in such a way as to generate the appearance of a propagating rainbow of colors (“rainbow chase”), given a particular placement of lighting units with respect to one another. In this example, the operator may provide a simple “rainbow chase” instruction to the central controller 202, and in turn the central controller may communicate to one or more LUCs using one or more Ethernet-based protocol high level commands to generate the rainbow chase. The command(s) may contain timing, intensity, hue, saturation or other relevant information, for example. When a given LUC receives such command(s), it may interpret the command(s) and communicate further command(s) to one or more lighting units using any one of a variety of protocols (e.g., Ethernet, DMX, serial-based), in response to which the respective sources of the lighting units are controlled via any of a variety of signaling techniques (e.g., PWM).

According to another embodiment, one or more LUCs of a lighting network may be coupled to a series connection of multiple lighting units 100 (e.g., see LUC 208A of FIG. 2, which is coupled to two series-connected lighting units 100). In one aspect of such an embodiment, each LUC coupled in this manner may be configured to communicate with the multiple lighting units using a serial-based communication protocol, examples of which are provided above. In one exemplary implementation, a given LUC may be configured to communicate with a central controller 202, and/or one or more other LUCs, using an Ethernet-based protocol, and in turn communicate with the multiple lighting units using a serial-based communication protocol. In such a way, a LUC may be viewed in one sense as a protocol converter that receives lighting instructions or data in an Ethernet-based protocol, and passes on the instructions to multiple serially-connected lighting units using a serial-based protocol. It should be appreciated however that in other network implementations involving DMX-based lighting units arranged in a variety of possible topologies, a given LUC similarly may be viewed as a protocol converter that receives lighting instructions or data in an Ethernet-based protocol, and passes on instructions formatted in a DMX protocol. It should again be appreciated that the foregoing example of using multiple different communication implementations (e.g., Ethernet/DMX) in a lighting system according to one embodiment of the present invention is for purposes of illustration only, and that the invention is not limited to this particular example.

From the foregoing, it may be appreciated that one or more lighting units as discussed above are capable of generating highly controllable variable color light over a wide range of colors, as well as variable color temperature white light over a wide range of color temperatures.

Certain aspects of the present invention relate to lighting fixtures generally discussed in U.S. Pat. No. 6,683,423 to Cunningham (the “Cunningham '423 patent”), incorporated herein by reference, and, more particularly, to a lighting apparatus suitable for use as part of such lighting fixtures, and configured to produce light having a selected color. Some aspects of the present invention further relate to a method for operating such lighting fixtures to provide light spectra useful in theatrical applications.

For example, one aspect of the present invention relates to a lighting apparatus for producing a beam of light having a controlled luminous flux spectrum including, for example, spectra emulating that of a beam of light produced by a predetermined light source, with or without a color filter. The lighting apparatus includes a plurality of groups of light-emitting devices, each such group configured to emit light having a distinct luminous flux spectrum, with a peak flux wavelength and a predetermined spectral half-width. In exemplary non-limiting implementations, the spectral half-width of each group may be less than about 40 nanometers (nm), and the groups may be configured such that the peak flux wavelength of each group is spaced less than about 50 nm from that of another group. The lighting apparatus may further include a controller configurable to supply selected amounts of electrical power to the groups of light-emitting devices, such that the groups cooperate to produce a composite beam of light having a prescribed luminous flux spectrum.

Another aspect of the present invention is directed to a lighting apparatus, suitable for use a part of a lighting fixture, for producing a beam of light having a luminous flux spectrum emulating that of a beam of light produced by a predetermined light source having an incandescent lamp, such light source being free of a filter that modifies the luminous flux spectrum of the light emitted by the lamp. The lighting apparatus includes a plurality of groups of light-emitting devices and further includes a controller configurable to supply selected amounts of electrical power to the groups of light-emitting devices. The groups cooperate to produce a composite beam of light having a prescribed luminous flux spectrum that has a normalized mean deviation across the visible spectrum of less than about 30% relative to the luminous flux spectrum of a beam of light produced by the predetermined light source to be emulated.

Yet another aspect of the present invention is directed to a lighting apparatus for producing a beam of light having a prescribed luminous flux spectrum, wherein at least two of a plurality of groups of light-emitting devices include different quantities of devices. The lighting apparatus further includes a controller configurable to supply selected amounts of electrical power to the groups of light-emitting devices, such that they cooperate to produce a composite beam of light having a prescribed luminous flux spectrum. The specific quantities of devices in each group may be selected to provide certain advantages when the lighting apparatus is used to emulate the luminous flux spectrum provided by a particular light source. For example, the quantities may be selected such that if the controller supplies maximum electrical power to all of the groups, then the resulting composite beam of light will have a luminous flux spectrum closely matching that of a beam of light that is to be emulated.

Yet another aspect of the present invention is directed to a lighting apparatus that includes five or more groups of light-emitting devices, and further includes a controller configurable to supply selected amounts of electrical power to the five or more groups of light-emitting devices, such that the groups cooperate to produce a composite beam of light having a prescribed luminous flux spectrum. In some embodiments, the lighting apparatus may include eight or more such groups of light-emitting devices, to facilitate greater control of the luminous flux spectrum of the composite beam of light generated by the lighting apparatus. In a particular implementation, the groups of light-emitting devices each may include a plurality of light-emitting diodes (LEDs). In addition, the lighting apparatus may optionally employ an optical assembly that collects the emitted light and projects the composite beam of the light from the lighting apparatus, as discussed in more detail below.

In some implementations, the present invention contemplates a lighting fixture configured to project a beam of light having a selected color. The lighting fixture may include an array of LEDs configured to emit light in a range of narrowband colors. A controller coupled to the array of LEDs may be configured to supply selected amounts of electrical power to the LEDs such that the combined light emitted from the fixture has a prescribed composite luminous flux spectrum. The array of LEDs may be mounted on a heat sink within a housing to facilitate the dissipation of heat from the LEDs. In some implementations, the wavelength bands of the LED groups may span substantially the entire visible spectrum, i.e., about 420 nanometers (nm) to about 680 nm. LEDs for emitting light in the requisite colors and at high intensities suitable for use with embodiments of the present invention may be obtained, for example, from Cree, Inc. of Durham, N.C., or Philips Lumileds of San Jose, Calif.

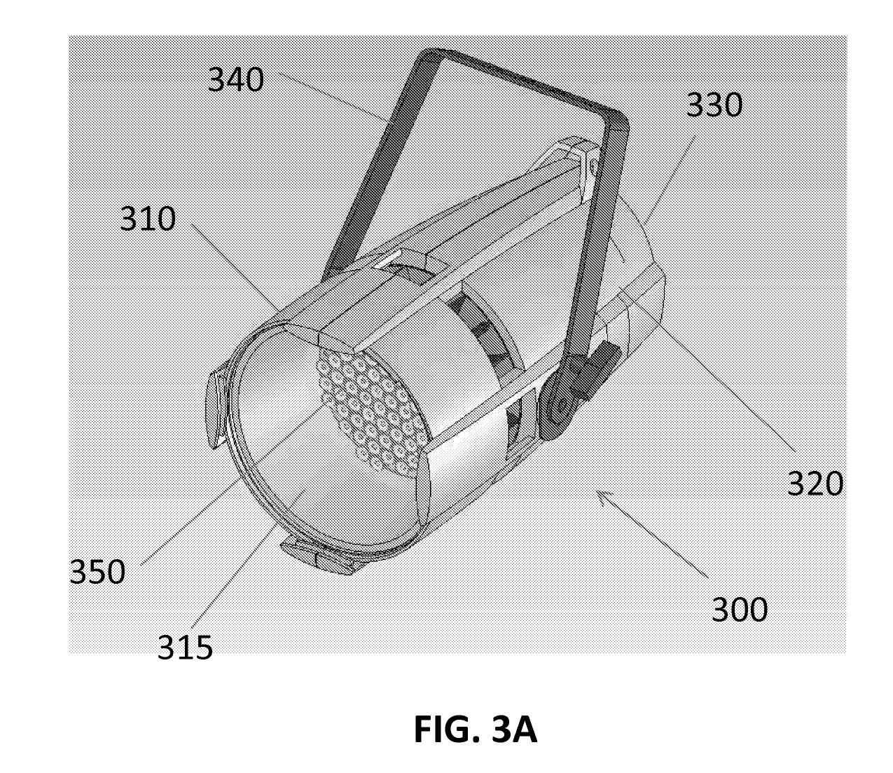

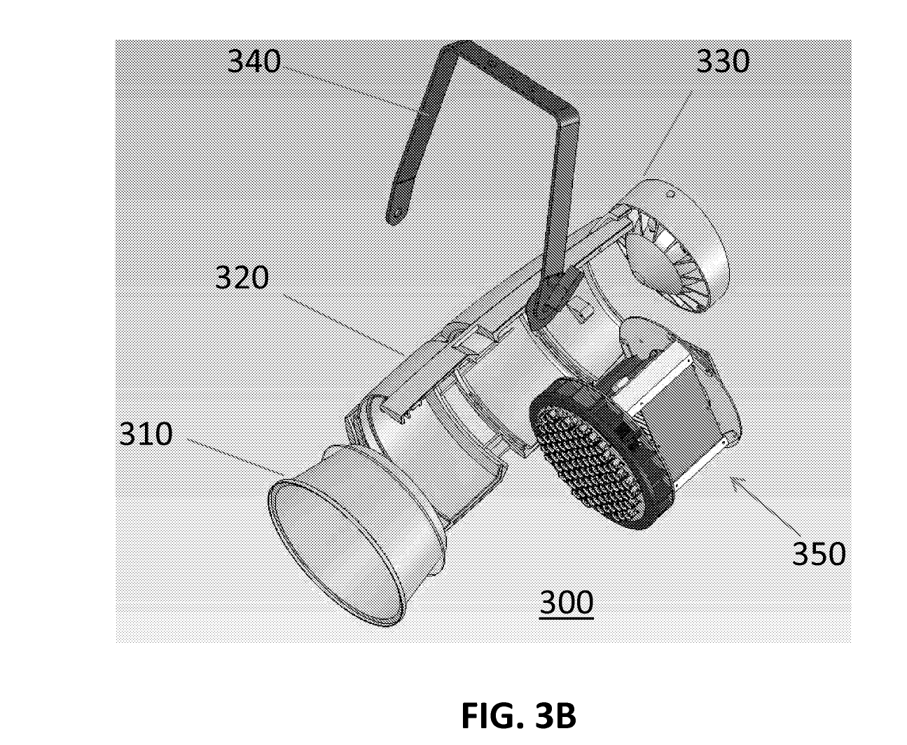

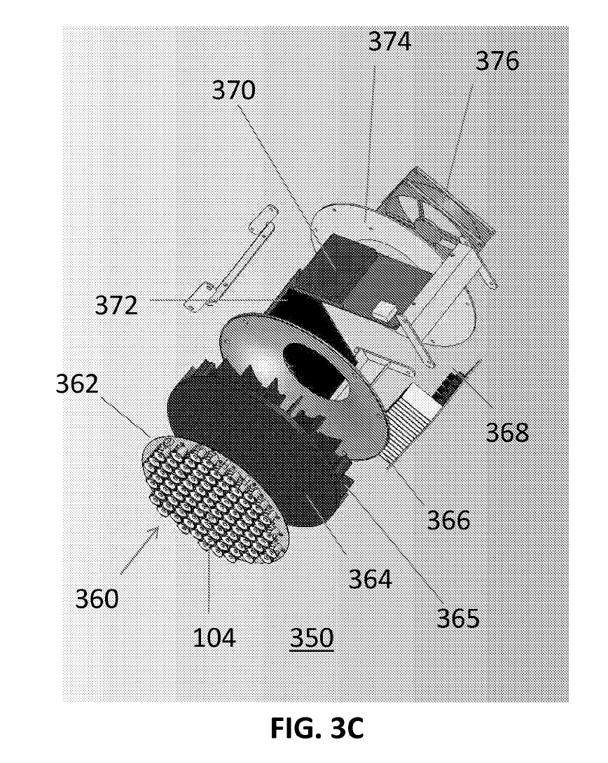

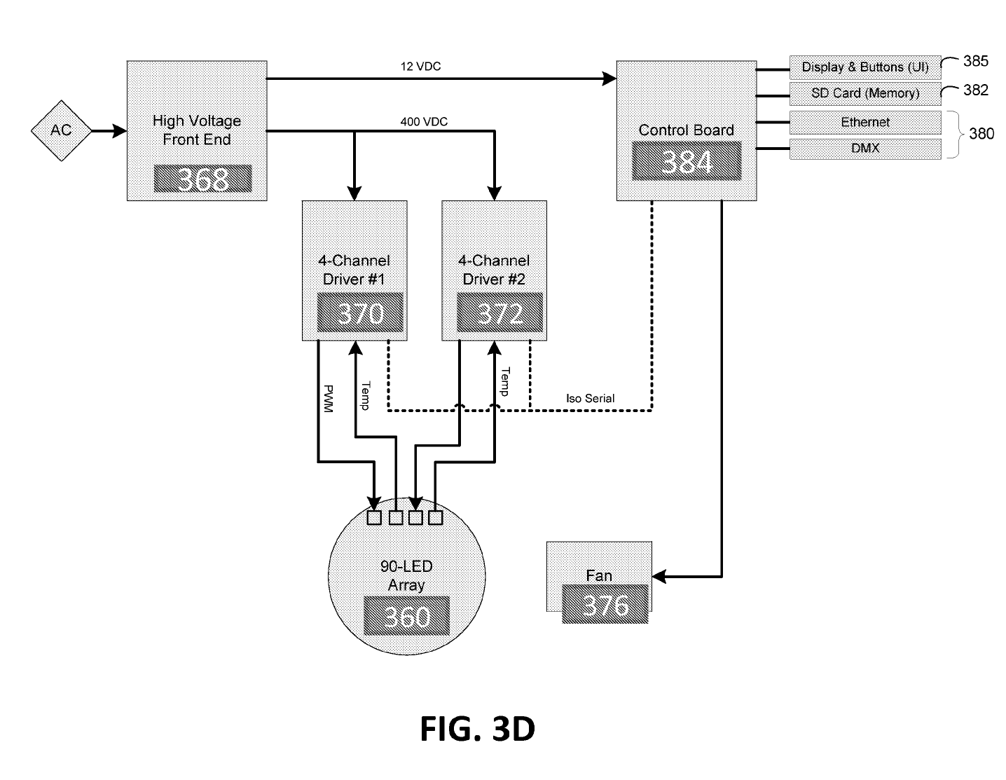

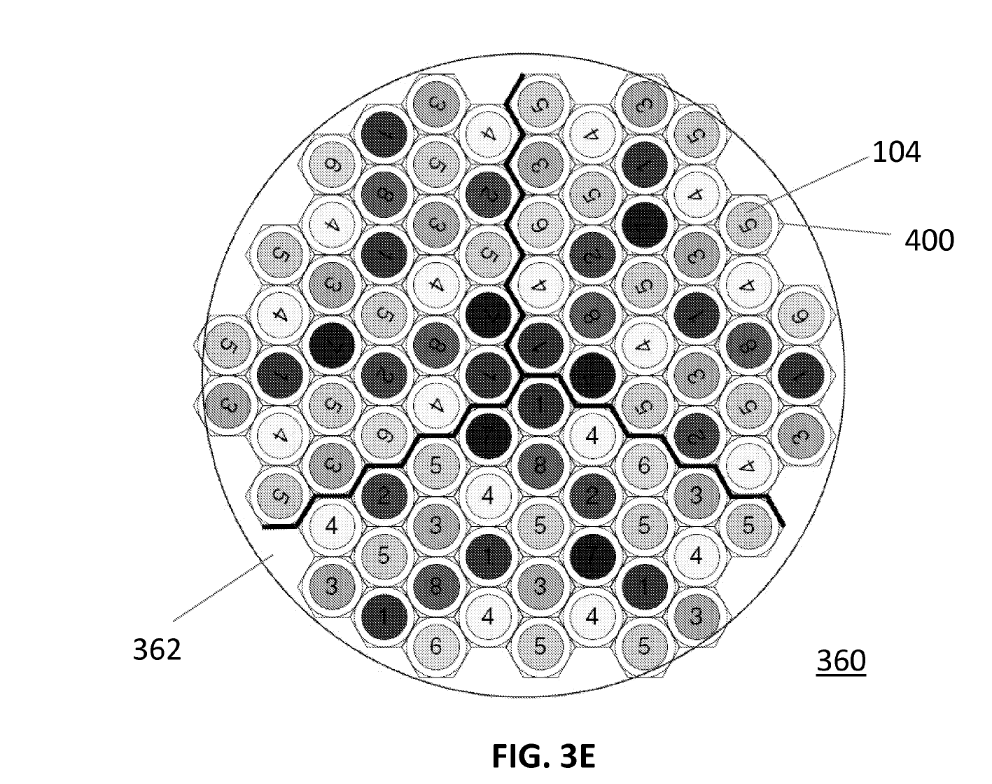

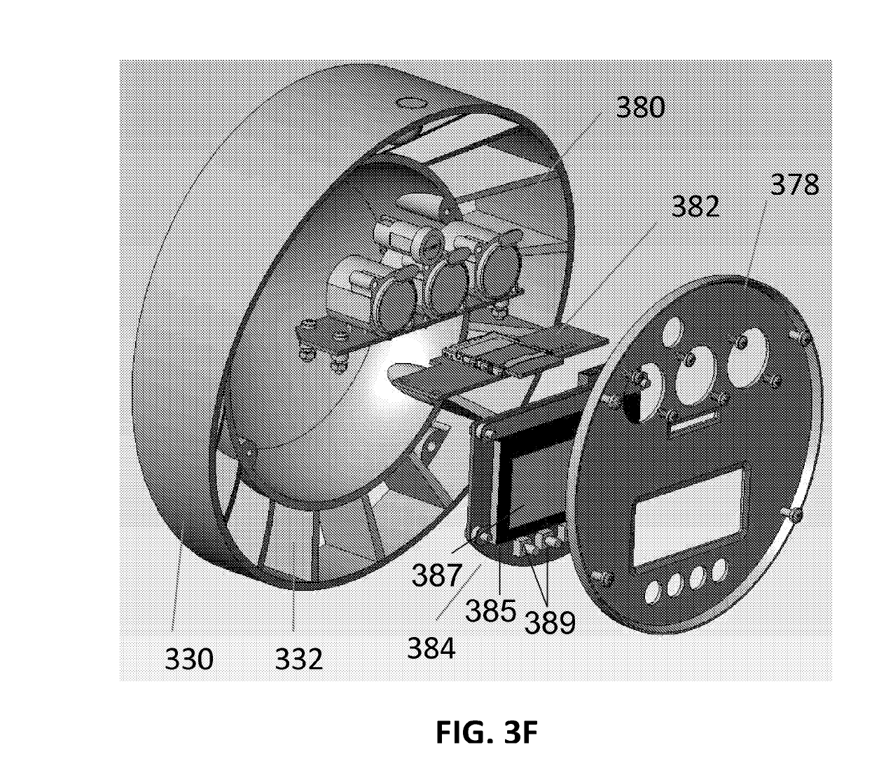

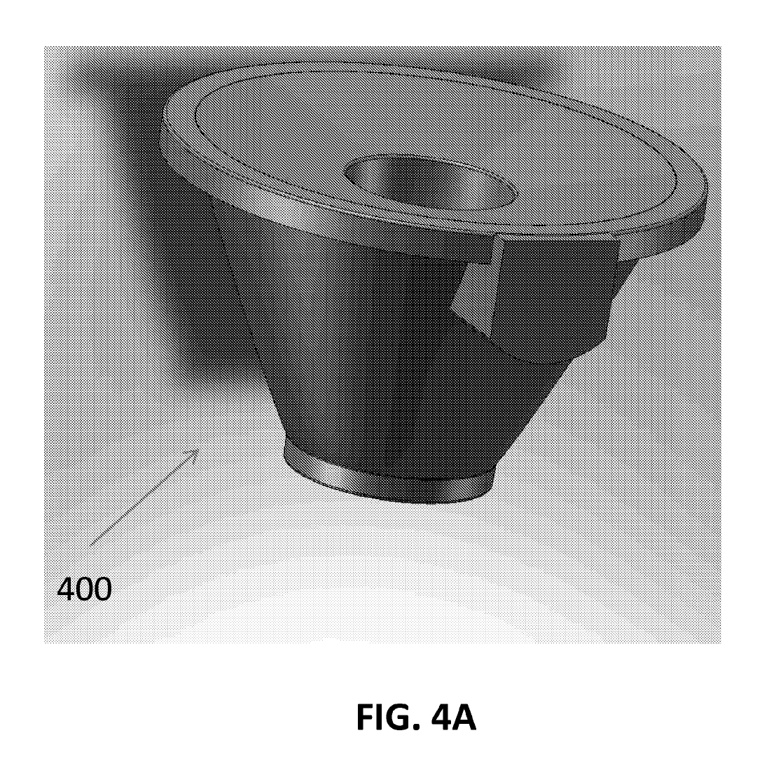

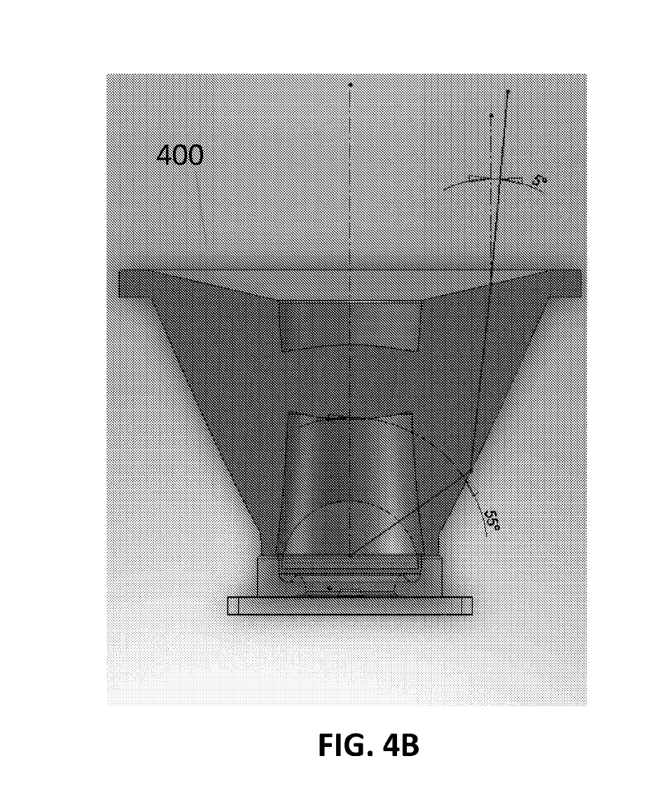

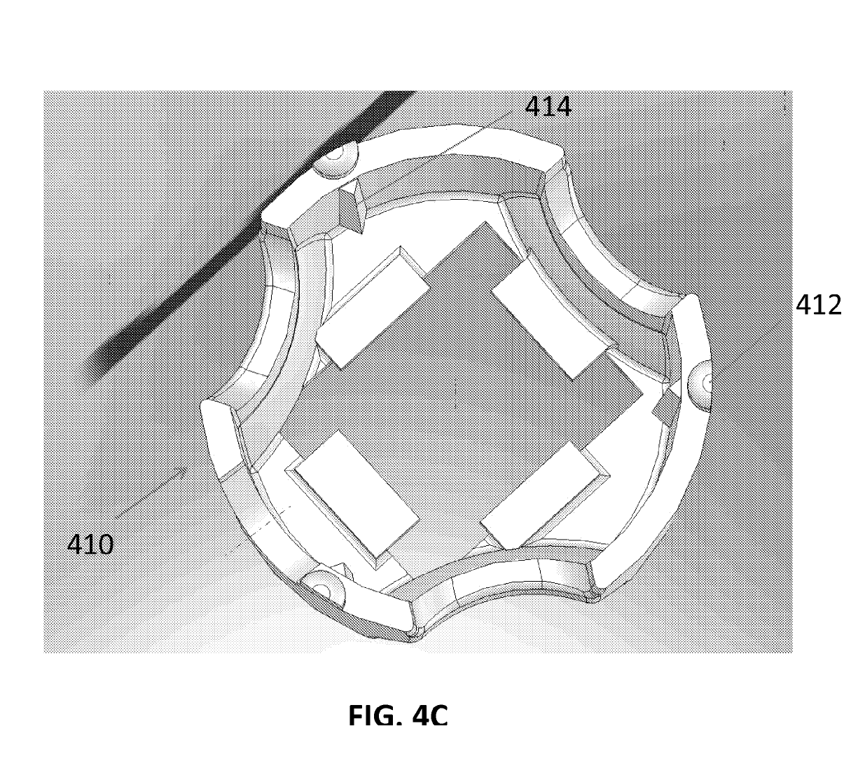

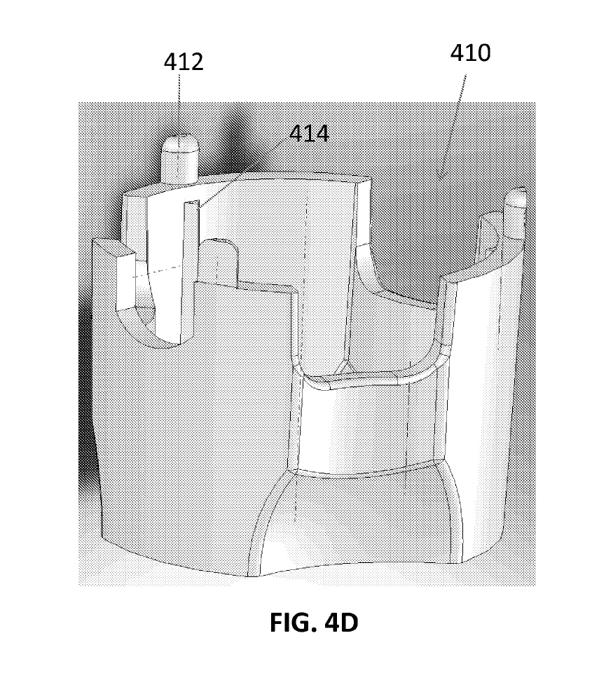

FIGS. 3A-4D illustrate a theatrical lighting fixture, and several components thereof, suitable for theatrical illumination according to various aspects of the present invention. In particular, as discussed in more detail below, the present invention contemplates a lighting fixture which provides improved energy efficiency, reduced weight, and/or a long fixture life compared to conventional lighting fixtures. In various embodiments described herein, a lighting fixture may employ one or more LED lighting units and one or more heat sinks to provide a path of cooling air that effectively removes heat generated by both the LED lighting units and/or various electrical components. An embodiment of a lighting fixture according to the present invention provides real-time, dynamic, controllable color-changing capability. In one implementation, a theatrical lighting fixture according to the present invention generates light output that emulates the spectra of light generated by conventional lighting fixtures.

In some embodiments of the present invention, a lighting fixture 300 includes a lens hood 310, one or more lenses 315, a housing 320, an end unit 330, a yoke 340, and an LED-based lighting assembly 350, as shown in FIGS. 3A and 3B. The LED-based lighting assembly 350 may include one or more light sources 104 as discussed above. The various components of lighting fixture 300 may be assembled as modular pieces to facilitate disassembly of the fixture to allow for servicing of the components, ease of storage, etc. In operation, for example, in stage or set applications, lighting fixture 300 can be mounted on any conventional support structure (not shown) in any desired orientation via clamps attached to yoke 340.

In one embodiment, lens hood 310 may be comprised of die-casted aluminum or plastic, such as a polycarbonate, and housing 320 and end unit 330 may also comprise a plastic, such as a polycarbonate. Some or all of the aforementioned lighting components may be manufactured using suitable methods, such as molding, casting, stamping, or the like. In one implementation, lens hood 310 may be configured to receive one or more interchangeable optical lenses 315. One or more optical lenses 315 may include, for example, a cover lens and a spread lens, although other configurations are also contemplated. Optical lens(es) 315 may be selected to achieve a desirable lighting effect or pattern (e.g., provide a continuous beam of light at a desired angle). For example, in some implementations, lighting fixture 300 employs a two-stage optical system, including LED collimators and a spread lens to provide a wash effect. The resultant light output may be a uniform pattern of light at various beam angles. In some embodiments, a diffuser may also be employed, and the diffuser may be placed, for example, about 100 mm from a collimator lens.

As mentioned above, in some embodiments, lens hood 310 may be configured such that optical lens(es) 315 can be interchanged, either before or after lighting fixture 300 is mounted to a support structure, to obtain a desired beam spread. For example, in some implementations, at least four basic light distributions may be achieved—a very narrow spot pattern may be realized by using a clear cover lens and collimator; a narrow spot may be realized by using only a diffuser (for example, a +/−5 degree diffuser); and a medium (e.g., beam angle of 12 degrees×18 degrees) or wide (e.g., beam angle of 17 degrees×27 degrees) flood light may be realized by using a spread lens with a diffuser. In some implementations, optical lenses may include a diffuser or a pillow optic to provide the desired beam angles. LED collimators according to some embodiments of the present invention are described in greater detail with reference to FIGS. 4A-4D.

In some embodiments, LED-based lighting assembly 350 includes an LED module 360, a heat sink 364, a shroud 366, a high voltage power supply circuit board 368, driver circuit boards 370 and 372, a mounting plate 374, and a fan 376, as shown in FIG. 3C. In various implementations, housing 320 may be configured to facilitate efficient dissipation of heat generated by assembly 350 by defining a number of openings 325 for air intake. As described in more detail below, various embodiment of the present invention are configured to provide a path of cooling air to remove heat generated by the LED module 360 and the power and control components of lighting fixture 300, resulting in improved energy efficiency and performance of the lighting assembly 350.

In some embodiments, LED module 360 includes multiple light sources 104, and may be constructed as a single printed circuit board 362 (as shown in FIG. 3E), discussed further below. LED module 360 may be attached to heat sink 364 using screws, which are disposed between adjacent light sources 104, or by using any other suitable fastening means including, but not limited to, bolts or adhesives. LED module 360 may additionally comprise an intermediate gap pad disposed on heat sink 364 to provide thermal connection and maintain electrical isolation between the printed circuit board 362 and heat sink 364. Referring to FIGS. 3A-3C, heat sink 364 may include fins 365 to increase the surface area of the heat sink in contact with the cooling air which is drawn into lighting fixture 300 by the action of fan 376 into and through heat sink 364 and upwards through shroud 366. Accordingly, heat may be transferred from LED module 360, through the fins 365 of heat sink 364, and be transported by the air flow established by fan 376. In one implementation, the fins 365 are substantially aligned with the openings 325 in the housing 320. Heat sink 364 may be comprised of aluminum or any other heat-conducting material by, for example, die-casting or machining. In other implementations of the present invention, a configuration other than, or in addition to fins 365 may be used to increase the surface area of the heat sink for improved heat removal.

In one embodiment, shroud 366 directs the flow of cooling air toward high voltage power supply circuit board 368 and driver circuit boards 370 and 372, thereby removing heat generated by them. Shroud 366 may be comprised of aluminum or plastic, and may be manufactured by molding, casting, stamping, or by any other suitable means. In some embodiments, mounting plate 374 comprises sheet metal and may be manufactured by stamping. Fan 376 may be selected from any of a number of readily available fans known to those skilled in the art. In particular, a low-noise fan may be used. The fan 376 may draw the cooling air through an aperture in mounting plate 374 and into end unit 330. Accordingly, lighting fixture 300 provides for effective removal of heat generated by both LED module 360 and the one or more various power and control components. Improved heat dissipation, in turn, leads to improved energy conversion and better performance and longevity of the components, and, ultimately, enhanced reliability and performance of the fixture.

As illustrated in FIGS. 3A-3D, in some implementations, high voltage power supply circuit board 368 may be a printed circuit board assembly that takes a universal AC input (85-264 V AC, 50/60 Hz) and outputs approximately 400 V DC at up to 350 watts. Additionally, power supply 368 may be power-factor corrected and may be 90% or more efficient at low line voltage (85 V AC), and greater than 95% efficient at 110 V AC and higher. In one implementation, power supply 368 may be built around the L6563 PFC controller chip, available from STMicroelectronics (Carrolton, Tex.), used in a “Fixed Off Time” configuration for high output power. In one exemplary implementation, power supply 368 may be made with standard, off-the-shelf components and at least one custom inductor. A large extruded aluminum heat sink may be integrated onto power supply circuit board 368, and a diode bridge, switching FET, and a switching diode may be mounted to the heat sink with a thermal grease interface, such that the heat sink and the switching diode are electrically isolated from each other. Power supply 368 may also provide a low voltage DC bias output of 12 V DC at 500 microamps, to power control board 384 (discussed further below in connection with FIG. 3D) and fan 376. In one implementation, a Power Integration TNY circuit (available from Power Integrations, Inc., of Sunnyvale, Calif.) may be used and adapted to run off a 400 V DC bus voltage. Such a circuit may require a small custom transformer, including adjustment of the number of windings and winding wire to achieve a desired configuration.

As shown in FIG. 3D, light sources 104 of LED module 360 are connected to driver circuit boards 370 and 372. Also connected to drivers 370 and 372 may be signals from temperature sensors disposed on LED module 360. In the illustrative example of FIGS. 3A-3D, each of drivers 370, 372 may drive 4 LED strings, using an inductive drive technique. The driver boards 370, 372 may receive a 400 V DC bus voltage from high voltage power supply 368, and communication of lighting control signals (or lighting commands) from the control board 384 to driver boards 370, 372 may be via an optically isolated high-speed serial bus with a half-duplex differential master/slave configuration. In one implementation, driver boards 370, 372 may be serial bus slaves, and control board 384, described in greater detail with reference to FIG. 3F, may be a serial bus master.

In one aspect, each of driver boards 370, 372 may include two microprocessors: a pulse-width modulation (PWM) processor and a feedback processor. The PWM processor may interpret lighting commands from control board 384 and may generate digital PWM signals to each of the 4 LED inductive drivers. In one aspect, as discussed in further detail below, a given lighting command provided by the control board 384 and processed by the PWM processor may include an “n-tuple” of channel values, wherein the n-tuple of channel values includes one value for each different color or color temperature of the plurality of LED light sources in the LED module (e.g., refer to the discussion above in connection with FIG. 1 regarding an [R,G,B] command format). The feedback processor may perform calibration and monitoring functions, such as monitoring voltage and current on each LED string as well as monitoring temperature sensor inputs. One or both microprocessors may be disposed on an optically isolated serial bus and they may also have direct, isolated digital connections in order to provide rapid response fault detection and channel disablement. In one implementation, the PWM processor and LED driver may be referenced to the low potential side of a 400 V DC input, while the feedback processor is referenced to the high potential side. In one implementation, the serial bus may be powered by and referenced to the control board 384.

In one implementation, LED module 360 includes light sources 104, which are configured in an array on circuit board 362. As shown in FIG. 3E, eight different colors may be represented by light sources 104: royal blue (λ=455-460 nm), blue (λ=470-475 nm), cyan (λ=505-510 nm), green (λ=525-530 nm), amber 1 (λ=585-590 nm), amber 2 (λ=595-600 nm), red-orange (λ=615-620 nm), and red (λ=630-635 nm). The present invention is not limited in this respect, and other sets or sub-sets of colors are contemplated without deviating from the scope and spirit of the invention.

In some implementations, light sources 104 of a given color may be connected in series, to provide eight strings of light sources 104, with one string per color. As shown in FIG. 3E, the light sources 104 may be arranged in an approximately circular hexagonally-packed pattern, with the colors randomly distributed to aid in color mixing for the composite output beam from lighting fixture 300. However, it should be appreciated that the light sources 104 may be configured in any suitable arrangement, and embodiments of the present invention are not limited in this respect. Table 1 below provides an example of a configuration of light sources 104 and their performance characteristics:

TABLE 1

| Color | Wavelength (nm) | Min Flux (lm) | Count |
|---|---|---|---|
| BRoyal Blue | 455-460 | 23.3 | 6 |
| Blue | 470-475 | 47.3 | 6 |
| Cyan | 505-510 | 80.1 | 6 |
| Green | 525-530 | 104 | 21 |
| Amber 1 | 585-590 | 59.5 | 18 |
| Amber 2 | 595-600 | 59.5 | 12 |
| Red-Orange | 615-620 | 89.2 | 9 |
| Red | 630-635 | 52.8 | 12 |
| Total | | 6309.6 | 90 |

In one exemplary implementation, light sources 104 may include XR-E 7090 LED units available from Cree, Inc. of Durham, N.C.

In some embodiments, LED module 360 may additionally employ temperature sensors (not shown), distributed across printed circuit board 362. The temperature sensors may include, for example, thermistors or other suitable temperature sensing devices generally known to those of skill in the art. In one implementation, printed circuit board 362 may have 4 layers, wherein the bottom layer is a continuous copper plane having a plurality of vias for heat transfer. Signal routing may occur on the top layer, adjacent light sources 104, and the two inner layers. In one implementation, blind vias may be provided between the top layer and the inner layers to reduce the risk of short circuits between the bottom layer and heat sink 364. While a particular arrangement of layers in printed circuit board 362 has been described in connection with FIG. 3E, it should be appreciated that various implementations may include any of a number of different printed circuit board configurations having one or more layers.

With reference to FIG. 3F, in one implementation end unit 330 may house various control circuitry/devices for lighting fixture 300. In one aspect, the end unit 330 may house three printed circuit boards: the control board 384 (discussed above in connection with FIG. 3D), a connector board 380, and a memory card board 382. In one aspect, the control board 384, as well as other boards disposed in the end unit, are substantially thermally isolated from the driver boards and the power supply board of the LED-based lighting assembly 350.

Control board 384 may include a main control processor, employing, for example, a microchip such as a dsPIC33FJ256GP710 chip, available from Microchip Technology, Inc. (Chandler, Ariz.). In some implementations, control board 384 may be configured to receive a DMX input and/or an Ethernet input (via one or more connectors of connector board 380, shown in FIG. 3F) and to provide an Ethernet output (e.g., for controlling drivers 370 and 372). For example, a first microchip (e.g., Microchip ENC28J60) may be used to provide a 10-megabit Ethernet interface, and a second microchip (e.g., Microchip TC664) may be used to provide fan control and feedback. Such microchips may be obtained from Microchip Technology, Inc. (Chandler, Ariz.), or from any other suitable source. Control board 384 may be provided with a 12V DC input power from the high voltage power supply 368. In some implementations, the input power may be regulated down to 5V DC with a switching regulator (e.g., an LM2594 switching regulator), and may further be stepped down to 3.3V DC with a linear regulator (e.g., an LT1521 linear regulator). The aforementioned regulators may be available from, for example, Semtech, Corp., of Newbury Park, Calif. A step-up converter (e.g., MAX8574 converter available from IC Plus, Inc., Torrance, Calif.) may be used to generate a 12V DC bias supply for an OLED display (or any other suitable type of display), under processor control.

In one implementation, the control board receives at least one input signal representing a desired output color or color temperature for the generated illumination, and processes the at least one input signal so as to provide at least one control signal representing a lighting command including an n-tuple of channel values, wherein the n-tuple of channel values includes one value for each different color or color temperature of the plurality of LED light sources. For example, in implementations in which there are eight different colors of LED light sources, the control board may provide as an output lighting commands in which each command includes eight different relative intensity values for the respective different colors, such that when specified proportions of the eight colors are mixed the desired output color or color temperature of illumination is achieved. In one implementation, the input signal(s) to the control board include(s) a representation of the desired output color in a multi-dimensional color space, and the control board is configured to map the representation of the desired output color in the multi-dimensional color space to the lighting command including the n-tuple of channel values. By way of example, as discussed further below, the multi-dimensional color space may include the hue-saturation-brightness (HSB) color space, the red-green-blue (RGB) color space, or the CIE color space. In another exemplary implementation, also discussed in greater detail below, the input signal(s) to the control board may include a representation of the desired output color in the form of a <source, filter> pair defining a source spectrum and gel filter color, and the control board may be configured to map the <source, filter> pair to the lighting command including the n-tuple of channel values.

In one aspect, the control board 384 calculates the PWM values for controlling strings of light sources 104, based at least in part on command input (e.g., received in a DMX or Ethernet format via connector board 380) and feedback from temperature sensors and other parameters. The control board 384 may also update and monitor a user interface (described in more detail below), and control the speed of fan 376 based on the selection of a user-controlled mode and/or temperature feedback. The main control processor may also be configured to perform electrical calibration of lighting fixture 300 via data received from the calibration processors at drivers 370 and 372.

In some embodiments, control board 384 may additionally comprise a user interface 385 including a graphics display 387 and tactile switch buttons 389 as shown in FIG. 3F. The graphics display may be, for example, an organic light-emitting diode (OLED) display. In one implementation, the user interface 385 may be configured to allow a user to specify a color of light to be output by the lighting apparatus by selecting one of a plurality of color modes. For example, in a first color mode, the user may specify a color selection for each of the LED string values directly. This may be accomplished using, for example, 8-bit/reduced or 16-bit/full resolution. In a second color mode, a user may select a standard color space such as hue-saturation-brightness (HSB) or red-green-blue (RGB). In a third color mode, a user may select a white color mode in which the color temperature of white light output from the lighting apparatus may be varied. In a fourth color mode, a user may select a Commission Internationale de l'Eclairage (CIE) coordinate in a CIE color space. In contrast to the HSB and RGB color spaces which are 3-dimensional spaces, the CIE color space is a 2-dimensional space.

In a fifth color mode, a user may select a <source, filter> pair defining a source lamp and gel number corresponding to standard values used in prior art lighting systems. In the fifth color mode, the present lighting fixture when provided with standard <source, filter> values may generate light output that closely approximates that of prior art lighting systems that employ incandescent or gas discharge lamps and standard color or dichroic filters. More particularly, in various implementations, the present invention contemplates a method for specifying a commanded output color for a multi-spectral light source by allowing the user to select a source spectrum (such as HPL750) and a gel color (such as Rosco 85, or R85) that the LED light fixture then replicates as closely as possible. In some implementations, such a command method may include (i) photometric measurement of source spectra and gel absorption spectra; (ii) precise measurement and calibration of each of the multitude of LED spectral sources; and (iii) firmware onboard the multi-spectral fixture that can map from a <source, filter> pair into a n-tuple of individual channel values, adjusting for operating temperature and individual channel photometrics. The spectral control functionality of the lighting sources described herein may enable adjusting the spectrum of the projected light based on known light absorption profiles of the surfaces being illuminated. In various implementations, methods according to the present invention for mapping a <source, filter> pair into a n-tuple of individual channel values may use one or more mathematical optimization methodologies to approximate a solution to the system of equations that represent or describe a theatrical lighting system.

While five different color modes have been described herein, it should be appreciated that the user interface and the associated circuitry on the control board 384 may be programmed or configured to produce any of a variety of desired light outputs, and embodiments of the present invention are not limited in this respect.

In some implementations, the main processor board 384 may further utilize various connectors for connections to power input, connector board 380, memory card board 382, an OLED display, or fan output. The control board 384 may further include a provision of a serial bus to driver boards 370, 372, as discussed above in connection with FIG. 3D. Memory card board 382 may optionally include a secure digital (SD) card, or another suitable memory device for storing digital media. In one implementation, the SD card (or other storage media) may be used to store configuration data for lighting fixture 300.

According to other aspects of the present invention, various optics may be used to alter the direction or focus of the light emitted from light sources 104. As shown in FIGS. 4A and 4B, a collimator 400 may fully enclose a single light source 104 to redirect the light generated by the light source 104 into a quasi-collimated beam. For example, if the light output from the enclosed light source 104 defines a 110-degree cone, collimator 400 may redirect this light into a 10-degree cone of light.

With reference again to FIG. 3E, in one illustrative example, each light source 104 may be coupled to its own collimator 400. In one implementation, at least some of the collimators 400 may be total internal reflection collimators having a center lens optic and being formed of polycarbonate material. Such a collimator 400 may have a gate, which allows for an easy molding process during manufacturing. With reference to FIG. 4B, in one aspect the distance of the center lens optic from the LED may be selected to contain the image of the LED within a 10-degree full width at half maximum (FWHM), and the other surfaces of the collimator may be configured as complex b-spline curves that are revolved into surfaces that redirect the light into the 10-degree FWHM area.

In some embodiments, collimator 400 may be affixed to the printed circuit board 362 using a mechanical holder such as collimator holder 410 shown in FIGS. 4C and 4D, although in other embodiments, a focusing optic and holder may be combined into a single attachable structure. Collimator holder 410 may be comprised of plastic, may be manufactured by, for example, a molding process, and may be shaped to facilitate provision of the configuration of the array of light sources 104, as illustrated in FIG. 3E. In a particular implementation illustrated in FIGS. 4C and 4D, a single collimator holder 410 is shaped to provide gaps between adjacent collimator holders 410, when affixed to the printed circuit board 362. Such a design facilitates access to screws/connectors that connect LED module 360 to heat sink 364.

In one implementation of the present invention, during the process of manufacturing lighting fixture 300, collimator holders 410 are affixed to the printed circuit board 362. Collimators 400 may then be placed into holders 410 and fixed into position with, for example, heat stake pins 412. In some implementations, collimator holders 410 may be aligned to the light sources 104 using a press fit. After holder 410 is affixed to the printed circuit board 362, collimator 400 may be placed into the holder 410. As shown in FIG. 4D, holder 410 may have one or more (e.g., three) guiding ribs 414 inside the holder to insure that collimator 400 does not have any tip or tilt. One or more heat staking pins 412 may be used to fix collimator 400 into position relative to printed circuit board 362.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present invention are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

1. A modular lighting fixture for providing theatrical illumination, the lighting fixture comprising:
an essentially cylindrically-shaped housing, the housing including at least one first opening for providing an air path through the lighting fixture;
an LED-based lighting assembly disposed in the housing, the LED-based lighting assembly comprising:
an LED module including a plurality of LED light sources having different colors and/or different color temperatures and disposed on a printed circuit board;
at least one first control circuit for controlling the plurality of LED light sources; and
at least one fan for providing a flow of cooling air along the air path through the lighting fixture;
an end unit removably coupled to the housing, the end unit including at least one second opening for providing the air path through the lighting fixture; and
at least one second control circuit disposed in the end unit, the at least one second control circuit electrically coupled to and substantially thermally isolated from the at least one first control circuit, wherein the LED-based lighting assembly is configured to direct the flow of the cooling air toward the at least one first control circuit so as to effectively remove heat generated by at least the at least one first control circuit.

2. The lighting fixture of claim 1, wherein the at least one first control circuit comprises:
at least one power supply circuit board; and
at least one driver circuit board

3. The lighting fixture of claim 2, wherein the LED-based lighting assembly further comprises:
a heat sink coupled to the LED module, the heat sink including a plurality of fins substantially aligned with the at least one first opening in the housing;
a shroud disposed proximate to the heat sink and configured to direct the flow of the cooling air toward the at least one power supply circuit board and the at least one driver circuit board; and
a mounting plate for mounting at least the at least one power supply circuit board and the at least one driver circuit board, the mounting plate having an aperture for providing the air path through the lighting fixture.

4. The lighting fixture of claim 1 further comprising a lens hood coupled to the housing for receiving one or more optical lenses.

5. The lighting fixture of claim 4, further including the one or more optical lenses, wherein the one or more optical lenses include a cover lens, a spread lens, a diffuser and/or a pillow optic.

6. The lighting fixture of claim 5, wherein the one or more optical lenses are interchangeable so as to provide for at least a very narrow spot beam spread, a narrow spot beam spread, a medium beam spread, and a wide beam spread.

7. The lighting fixture of claim 1, further comprising a yoke coupled to the housing for mounting the lighting fixture.

8. The lighting fixture of claim 1, wherein the plurality of LED light sources include at least eight different colors of LED light sources.

9. The lighting fixture of claim 8, wherein the plurality of LED light sources are electrically connected so as to form at least eight strings of series-connected light sources, wherein the plurality of light sources are arranged in an approximately circular hexagonally-packed pattern on the printed circuit board, and wherein the at least eight different colors of LED light sources are randomly distributed on the printed circuit board.

10. The lighting fixture of claim 2, wherein the at least one power supply circuit board includes a power factor correction (PFC) controller and receives an AC voltage input in a range of approximately 85 to 240 Volts and provides a first DC output voltage of approximately 400 Volts and a second DC output voltage of approximately 12 Volts.

11. The lighting fixture of claim 2, wherein the at least one driver circuit board implements an inductive drive technique to drive the plurality of LED light sources.

12. The lighting fixture of claim 11, wherein the at least one driver circuit board comprises:
a pulse-width modulation (PWM) processor for generating digital PWM signals based on at least one control signal received from the at least one second control circuit; and
a feedback processor for performing calibration functions and/or monitoring functions including monitoring one or more of voltage, current and temperature.

13. The lighting fixture of claim 12, wherein the LED module includes at least one temperature sensor for monitoring a temperature of the LED module, and wherein the monitoring functions performed by the feedback processor include monitoring the temperature of the LED module.

14. The lighting fixture of claim 8, wherein the at least one driver circuit board includes:
a first driver circuit board for controlling a first group of four colors of the at least eight different colors of LED light sources; and
a second driver circuit board for controlling a second group of four colors of the at least eight different colors of LED light source.

15. The lighting fixture of claim 2, wherein the at least one second control circuit is configured to receive at least one input signal representing a desired output color for the lighting fixture, and wherein based on the input signal the at least one second control circuit provides to the at least one driver board at least one control signal representing a lighting command including an n-tuple of channel values, wherein the n-tuple of channel values includes one value for each different color or color temperature of the plurality of LED light sources.

16. The lighting fixture of claim 15, wherein the at least one input signal includes a representation of the desired output color in a multi-dimensional color space, and wherein the at least one second control circuit maps the representation of the desired output color in the multi-dimensional color space to the lighting command including the n-tuple of channel values.

17. The lighting fixture of claim 15, wherein the at least one input signal includes a representation of the desired output color in the form of a <source, filter> pair defining a source spectrum and gel filter color, and wherein the at least one second control circuit maps the <source, filter> pair to the lighting command including the n-tuple of channel values.

18. The lighting fixture of claim 15, wherein the at least one second control circuit is configured to receive the at least one input signal as at least one DMX-formatted and/or Ethernet-formatted input signal, and provide the at least one control signal to the at least one driver board as at least one Ethernet-formatted control signal.

19. The lighting fixture of claim 18, wherein the Ethernet-formatted control signal is provided to the at least one driver board via an optically isolated high-speed serial bus with a half-duplex differential master/slave configuration.

20. The lighting fixture of claim 2, wherein the at least one second control circuit includes a user interface including a graphics display, wherein the user interface allows a user to specify a color of light to be output by the lighting fixture by selecting one of a plurality of color modes.

21. The lighting fixture of claim 1, wherein the LED module further includes a collimator for each light source of the plurality of LED light sources.

22. The lighting fixture of claim 21, wherein the LED module further includes a collimator holder for each light source of the plurality of LED light sources, wherein the collimator holder is affixed to the printed circuit board via one or more heat-staking pins, and wherein the collimator is disposed in the collimator holder.

23. A method for providing theatrical illumination from a lighting fixture including a plurality of LED light sources having different colors and/or color temperatures, the method comprising:
A) receiving at least one input signal representing a desired output color or color temperature for the illumination; and
B) processing the at least one input signal so as to provide at least one control signal representing a lighting command including an n-tuple of channel values, wherein the n-tuple of channel values includes one value for each different color or color temperature of the plurality of LED light sources.

24. The method of claim 23, wherein the at least one input signal includes a representation of the desired output color in a multi-dimensional color space, and wherein B) comprises:
mapping the representation of the desired output color in the multi-dimensional color space to the lighting command including the n-tuple of channel values.

25. The method of claim 23, wherein the at least one input signal includes a representation of the desired output color in the form of a <source, filter> pair defining a source spectrum and gel filter color, and wherein B) comprises:
mapping the <source, filter> pair to the lighting command including the n-tuple of channel values.

26. The method of claim 23, wherein A) comprises receiving the at least one input signal as at least one DMX-formatted and/or Ethernet-formatted input signal, and wherein B) comprises providing the at least one control signal as at least one Ethernet-formatted control signal.
